(19) United States
(12) Patent Application Publication
(10) Pub. No.: US 2017/0076531 A1
(43) Pub. Date: Mar. 16, 2017

(54) MONEY HANDLING APPARATUS AND MONEY HANDLING METHOD

(71) Applicant: GLORY LTD., Himeji-shi (JP)

(72) Inventors: Keisuke NADA, Hyogo (JP); Kazuya NISHINO, Hyogo (JP); Tadashi SHIMIZU, Hyogo (JP)

(73) Assignee: GLORY LTD., Himeji-shi (JP)

(21) Appl. No.: 15/259,328

(22) Filed: Sep. 8, 2016

(30) Foreign Application Priority Data
Sep. 15, 2015 (JP) 2015-181925

(51) Int. Cl. G07D 11/00

(52) U.S. Cl. CPC G07D 11/0084; G07D 11/0066

(57) ABSTRACT

An objective of the present disclosure is to provide a money handling apparatus including a storage unit for storing therein money of a plurality of kinds are stored, in which a storage amount, in the storage unit, for money of kinds other than a predetermined kind can be secured. In the money handling apparatus, a recognition unit 11 recognizes money to be handled. A storage unit 19 stores money of a plurality of kinds on the basis of at least one of the result of recognition by the recognition unit 11 and the result of handling by the money handling apparatus. A memory unit 40 stores, for at least one kind among the plurality of kinds, an upper-limit storage amount of money in the storage unit 19.

### CROSS REFERENCE TO RELATED APPLICATION

The disclosure of Japanese Patent Application No. 2015-181925, filed on Sep. 15, 2015, is incorporated herein by reference.

### BACKGROUND OF THE INVENTION

Field of the Invention

The techniques disclosed herein relate to money handling apparatus and money handling methods for performing depositing of money or depositing and dispensing of money.

Description of the Background Art

To date, money handling apparatus that are installed in financial facilities such as banks and perform depositing and dispensing of money have been known. For example, Japanese Laid-Open Patent Publication No. 2011-198145 (Patent Literature 1) discloses a banknote handling apparatus in which denominations, authenticities and the like of banknotes inserted into a depositing unit are recognized by a recognition unit, and the banknotes recognized as proper banknotes are stored in storage units by denominations. The banknotes stored in the storage units are dispensed to a dispensing unit in response to an operation performed by an operator.

In some money handling apparatus, money of a plurality of kinds are stored in a single storage unit. For example, the banknote handling apparatus disclosed in Patent Literature 1 includes a stacking unit 19. Banknotes to be stored in the stacking unit 19 include: banknotes (unfit notes) that are not suitable for recycling; banknotes of a denomination to which no storage unit is assigned; banknotes (deposit-overflow banknotes) that have overflowed from a storage unit; banknotes (dispense-rejected banknotes) that have been rejected in dispensing from the apparatus; and the like.

However, if a large amount of money of a specific kind is stored in the storage unit that stores money of a plurality of kinds, the storage unit becomes full and cannot store money of other kinds. This makes it difficult to execute a process in which money of other kinds are required to be stored in the storage unit. For example, in the banknote handling apparatus disclosed in Patent Literature 1, if the stacking unit 19 becomes full because banknotes that are in great circulation are inserted and thereby a plurality of deposit-overflow banknotes are generated, dispense-rejected banknotes cannot be stored in the stacking unit 19. In this case, since there is no place to store the dispense-rejected banknotes, dispensing cannot be performed. Also when, for example, a large amount of money of a specific denomination is stored in the storage unit that stores money of a plurality of denominations, money of other denominations cannot be stored in the storage unit, resulting in the same problem as described above.

The techniques disclosed herein are made in view of the above-mentioned problems, and an object of the disclosure is to provide a money handling apparatus including a storage unit that stores money of a plurality of kinds, in which a storage amount of money other than money of a specified kind can be secured in the storage unit.

### SUMMARY OF THE INVENTION

A technique disclosed herein is a money handling apparatus configured to handle money, including: a recognition unit configured to recognize money to be handled; a storage unit configured to store money of a plurality of kinds, on the basis of at least one of a result of recognition by the recognition unit and a result of handling by the money handling apparatus; and a memory unit configured to store, for at least one kind among the plurality of kinds, an upper-limit storage amount of money in the storage unit.

According to this configuration, regarding the storage unit that stores money of a plurality of kinds, the memory unit stores, for at least one kind among the plurality of kinds, an upper-limit storage amount of money in the storage unit. Thus, in the storage unit, the amount of stored money of a predetermined kind for which an upper-limit storage amount is stored in the memory unit can be limited, whereby a storage amount of money in the storage unit can be secured for the kinds other than the predetermined kind among the plurality of kinds.

The money handling apparatus may include: a transport unit configured to transport the money being handled; and a transport control unit configured to control, with reference to the memory unit, a destination of the money transported by the transport unit, so that an amount of the money of the at least one kind stored in the storage unit does not exceed the upper-limit storage amount stored in the memory unit.

According to this configuration, the destination of the money transported by the transport unit is controlled so that the amount of money of a predetermined kind stored in the storage unit does not exceed the upper-limit storage amount stored in the memory unit. Therefore, a storage amount of money in the storage unit can be secured for the kinds other than the predetermined kind among the plurality of kinds.

The memory unit may store, as the upper-limit storage amount, a number of pieces of the money of the kind, a monetary amount of the money of the kind, or a ratio of an amount of the money of the kind stored in the storage unit to a maximum storage capacity of the storage unit.

According to this configuration, the upper-limit storage amount in the storage unit is stored in the memory unit, as a number of pieces of money, a monetary amount of money, or a ratio of an amount of stored money to a maximum storage capacity of the storage unit.

The money handling apparatus may include a setting control unit capable of changing the upper-limit storage amount that is stored in the memory unit.

According to this configuration, the upper-limit storage amount in the storage unit can be changed.

The money handling apparatus may include a denomination-specific storage unit configured to store money by denominations, and the storage unit and the denomination-specific storage unit may be managed under different authorities.

The storage unit may be a storage-only unit that performs only storage of money.

In the money handling apparatus, in a depositing process of depositing money into the apparatus, in a case where inserted money is determined to be stored in the storage unit, when the money belongs to any of the at least one kind and an amount of the money of the kind stored in the storage unit has reached the upper-limit storage amount, the money may be rejected, and the depositing process may be continued.

According to this configuration, in the depositing process of depositing money into the apparatus, in the case where inserted money is determined to be stored in the storage unit, when the amount of stored money of a kind to which the inserted money belongs has reached the upper-limit storage amount in the storage unit, the money is rejected, and the depositing process is continued.

In the money handling apparatus, in a dispensing process of dispensing money to the outside of the apparatus, in a case where money to be dispensed is determined to be stored in the storage unit, when the money belongs to any of the at least one kind and an amount of the money of the kind stored in the storage unit has reached the upper-limit storage amount, the dispensing process may be stopped.

According to this configuration, in the dispensing process of dispensing money to the outside of the apparatus, in the case where money to be dispensed is determined to be stored in the storage unit, when the amount of stored money of a kind to which the money to be dispensed belongs has reached the upper-limit storage amount in the storage unit, the dispensing process is stopped.

A technique disclosed herein is a money handling apparatus configured to handle money, including: an insertion unit into which money is inserted; a dispensing unit from which money is dispensed; a denomination-specific storage unit configured to store money by denominations; a transport unit configured to transport money inserted into the insertion unit in a depositing process, and transport money fed from the denomination-specific storage unit in a dispensing process; a recognition unit configured to recognize the money transported by the transport unit; a second storage unit provided separately from the denomination-specific storage unit, and configured to store at least dispense-rejected money that is recognized by the recognition unit as being inappropriate for dispensing in the dispensing process; and a transport control unit configured to control a destination of the money transported by the transport unit, on the basis of at least a result of recognition by the recognition unit. In the depositing process, the transport control unit controls the transport unit to transport the money to the second storage unit when the inserted money satisfies a predetermined condition, and restricts transport of the money to the second storage unit when an amount of money stored in the second storage unit has reached a set upper-limit storage amount in the depositing process.

According to this configuration, in the depositing process, when inserted money satisfies the predetermined condition, the transport control unit controls the transport unit so that this money is transported to the second storage unit for storing dispense-rejected money. In this case, however, if the amount of money stored in the second storage unit has reached the set upper-limit storage amount in the depositing process, transport control unit restricts transport of the money to the second storage unit. Thus, in the second storage unit, the amount of stored money in the depositing process can be limited, whereby a storage amount for the dispense-rejected money can be secured. The money for which depositing is restricted is rejected to the depositing reject unit, for example.

In the money handling apparatus, the predetermined condition may include at least one of: a condition that an amount of the money, for a corresponding denomination, stored in the denomination-specific storage unit has reached an upper-limit storage amount; a condition that the denomination of the money is assigned to none of the denomination-specific storage unit; and a condition that the money is recognized as an unfit note by the recognition unit.

According to this configuration, the inserted money is transported to the second storage unit when the amount of money, corresponding to the denomination of the inserted money, stored in the denomination-specific storage unit has reached the upper-limit storage amount, or when the denomination of the inserted money is assigned to none of the denomination-specific storage unit, or when the inserted money is recognized as an unfit note.

In the money handling apparatus, the dispense-rejected money may be stored only in the second storage unit in the money handling apparatus.

The transport control unit may be configured to be able to cancel restriction on transport of money to the second storage unit on the basis of the set upper-limit storage amount in the depositing process.

According to this configuration, restriction on transport of money to the second storage unit on the basis of the set upper-limit storage amount in the depositing process can be canceled.

A technique disclosed herein is a method of handling money in a money handling apparatus, including: transporting, by a transport unit, money being handled; recognizing, by a recognition unit, the money being transported by the transport unit; controlling, by a transport control unit, the transport unit so that, among the money transported by the transport unit, money of a plurality of kinds are stored in a storage unit, on the basis of at least one of a result of recognition by the recognition unit and a result of handling by the money handling apparatus; and controlling, by the transport control unit, with reference to a memory unit that stores an upper-limit storage amount of money in the storage unit, a destination of the money transported by the transport unit so that, regarding at least one kind among the plurality of kinds, an amount of money of the at least one kind stored in the storage unit does not exceed the upper-limit storage amount stored in the memory unit.

According to this configuration, the transport control unit controls the destination of the money transported by the transport unit so that the amount of money of a predetermined type stored in the storage unit that stores money of a plurality of kinds does not exceed the upper-limit storage amount stored in the memory unit. Thus, a storage amount of money in the storage unit can be secured for the kinds other than the predetermined kind among the plurality of kinds.

A technique disclosed herein is a method of handling money in a money handling apparatus, including: transporting, by a transport unit, money in a depositing process, and transporting, by the transport unit, money fed from a denomination-specific storage unit in a dispensing process; recognizing, by a recognition unit, the money being transported by the transport unit; controlling, by a transport control unit, the transport unit so that dispense-rejected money that is recognized to be inappropriate for dispensing by the recognition unit in the dispensing process is stored in a second storage unit provided separately from the denomination-specific storage unit; and controlling, by the transport control unit, the transport unit so that, when inserted money satisfies a predetermined condition in the depositing process, the money is transported to the second storage unit, and restricting, by the transport control unit, transport of the money to the second storage unit when an amount of money stored in the second storage unit has reached a set upper-limit storage amount in the depositing process.

According to this configuration, in the depositing process, when inserted money satisfies the predetermined condition, the transport control unit controls the transport unit so that this money is transported to the second storage unit for storing dispense-rejected money. In this case, however, if the amount of money stored in the second storage unit has reached the set upper-limit storage amount in the depositing process, transport control unit restricts transport of the money to the second storage unit. Thus, in the second storage unit, the amount of stored money in the depositing process can be limited, whereby a storage amount for the dispense-rejected money can be secured.

According to the present disclosure, in the storage unit that stores money of a plurality of kinds, control is performed such that the amount of money of a predetermined kind stored in the storage unit does not exceed an upper-limit storage amount. Therefore, it is possible secure a storage amount of money of kinds other than the predetermined kind. Further, according to the present disclosure, in the second storage unit that stores dispense-rejected money, the amount of money stored therein in depositing can be limited. Therefore, it is possible to secure a storage amount of the dispense-rejected money.

### BRIEF DESCRIPTION OF THE DRAWINGS

FIG. 1 shows an overall structure of a banknote handling apparatus;

FIG. 2 is a block diagram showing a functional structure of the banknote handling apparatus;

FIG. 3 shows an example of setting of upper-limit storage amounts;

FIG. 4 is a flowchart showing an example of operation in depositing;

FIG. 5A schematically shows transport operation;

FIG. 5B schematically shows the transport operation;

FIG. 5C schematically shows the transport operation;

FIG. 6 is a flowchart showing an example of operation in dispensing; and

FIG. 7 shows another example of setting of upper-limit storage amounts.

### DESCRIPTION OF THE PREFERRED EMBODIMENTS

Hereinafter, an embodiment of a money handling apparatus will be described with reference to the drawings. The following description will be given using a banknote handling apparatus that performs depositing and dispensing of banknotes, as an example of the money handling apparatus. However, the techniques disclosed herein are also applicable to, for example, a banknote handling apparatus that performs only depositing of banknotes. In addition, the techniques disclosed herein are also applicable to a coin handling apparatus that performs depositing and dispensing of coins or depositing of coins.

(Overall Structure of Banknote Handling Apparatus)

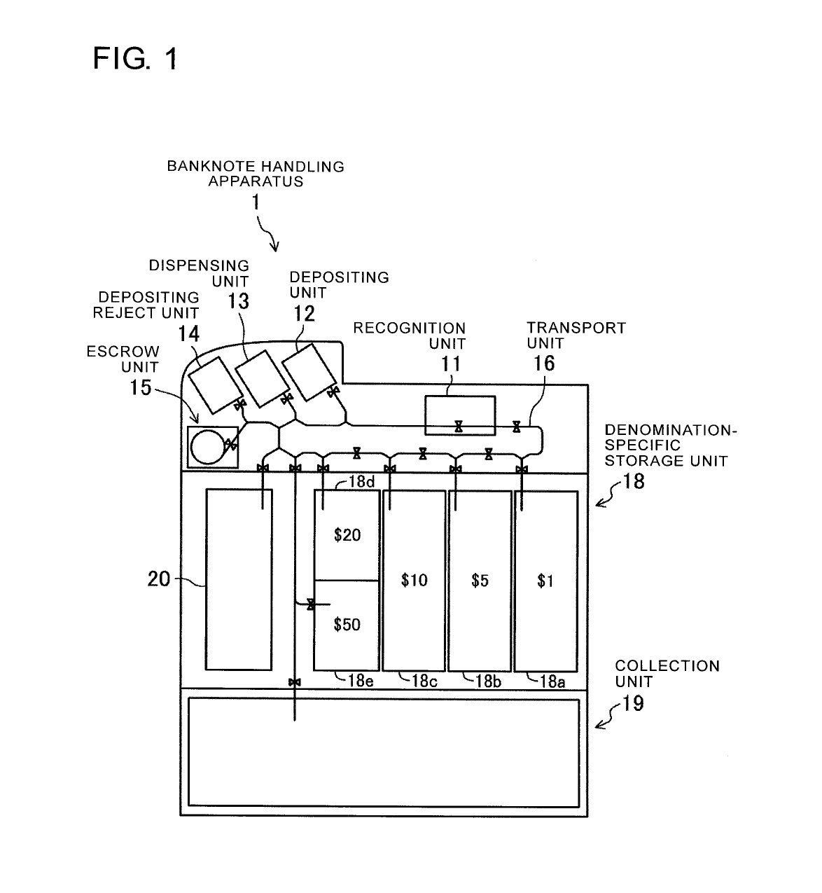

FIG. 1 shows the overall structure of the banknote handling apparatus. As shown in FIG. 1, the banknote handling apparatus 1 includes a recognition unit 11, a depositing unit 12, a dispensing unit 13, a depositing reject unit 14, an escrow unit 15, a transport unit 16, a denomination-specific storage unit 18, a collection unit 19, and a reconciliation cassette 20.

The recognition unit 11 recognizes banknotes transported by the transport unit 16. Specifically, the recognition unit 11 performs various judgments such as denomination judgment, authenticity judgment, fitness judgment, and face/back judgment on the banknotes transported by the transport unit 16. The authenticity judgment indicates judging whether a banknote is a genuine banknote or a counterfeit banknote. The fitness judgment indicates judging whether a genuine banknote is a banknote in a good condition (fit banknote) or a stained or torn banknote (unfit banknote).

The depositing unit 12 is, for example, a box having an opening formed by shaping a top surface part of the apparatus into a recess. Banknotes to be deposited are fed one by one to the transport unit 16 inside the apparatus by a feeding unit such as rollers provided inside or near the box. Feeding of the banknotes to be deposited may be started manually or automatically. The depositing unit 12 is an example of an insertion unit according to the present disclosure.

The dispensing unit 13 is, for example, a box having an opening formed in a similar manner to the depositing unit 12. Banknotes to be dispensed, which are discharged from the inside of the apparatus, are stacked in the dispensing unit 13 in accordance with a dispensing instruction by the operator. The dispensing unit 13 is also utilized as one of dispensing destinations for banknotes that are determined not to be stored by the banknote handling apparatus 1, that is, rejected banknotes. The dispensing unit 13 is an example of a dispensing unit according to the present disclosure.

The depositing reject unit 14 is an outlet portion in which rejected banknotes are stacked. The banknote handling apparatus 1 utilizes, as a dispensing destination for rejected banknotes, at least one of the dispensing unit 13 and the depositing reject unit 14.

The escrow unit 15 is, for example, a tape-type storing and feeding unit. The escrow unit 15 is a storing and feeding unit that can feed-in the banknotes transported by the transport unit 16 to escrow the banknotes, and also can feed-out the escrowed banknotes.

The transport unit 16 transports banknotes inserted into the depositing unit 12. The transport unit 16 includes, for example, a belt conveyer that transports the banknotes, one by one, being nipped from both sides (i.e., face-side and back-side), and a drive unit for the belt conveyer. Specifically, the transport unit 16 connects the recognition unit 11, the depositing unit 12, the dispensing unit 13, the depositing reject unit 14, the escrow unit 15, the denomination-specific storage unit 18, the collection unit 19, and the reconciliation cassette 20 to one another via the belt conveyer, and transports the banknotes between these units.

The drive unit for the belt conveyer includes rollers to drive the belt conveyer, a path diverter arranged at each branch point of the transport unit 16, and the like. The path diverter swings between, for example, a position at which the banknotes are directly transported downstream of the transport unit 16 and a position at which the banknotes are transported to the respective units (e.g., the dispensing unit 13 and the depositing reject unit 14).

The denomination-specific storage unit 18 includes a plurality of cassettes 18a to 18e in which the banknotes transported by the transport unit 16 are stored by denominations. Each of the cassettes 18a to 18e includes a feeding mechanism for feeding the stored banknotes to the transport unit 16. In addition, each of the cassettes 18a to 18e includes an indicator such as a lamp that notifies the operator of a storage error such as the cassette being full or malfunctioning.

It is assumed that the cassette 18a stores 1-dollar notes, the cassette 18b stores 5-dollar notes, the cassette 18c stores 10-dollar notes, the cassette 18d stores 20-dollar notes, and the cassette 18e stores 50-dollar notes. Meanwhile, the operator can assign any denomination to each of the cassettes 18a to 18e, as desired.

The collection unit 19 is an example of a storage unit according to the present disclosure. In this embodiment, the collection unit 19 has a cassette type structure. Unlike the denomination-specific storage unit 18, the collection unit 19 is only for storing banknotes therein, and does not have a feeding mechanism. The collection unit 19 stores, for example, sales proceeds or the like therein at the close of business. The collection unit 19 may be, for example, managed under an authority different from that for the denomination-specific storage unit 18. In this case, for example, the denomination-specific storage unit 18 is managed by a store such as a bank while the collection unit 19 is managed by a security transportation company.

The reconciliation cassette 20 is a cash cassette that is detachable from the banknote handling apparatus 1. The reconciliation cassette 20 is used, when the number of banknotes stored in any of the cassettes 18a to 18e becomes uncertain due to a banknote jam or the like, to reconcile the number of the banknotes in the cassette. The reconciliation cassette 20 stores banknotes therein and also feeds the stored banknotes to the transport unit 16, in the same manner as the cassettes 18a to 18e.

(Functional Structure and Setting of Upper-Limit Storage Amount)

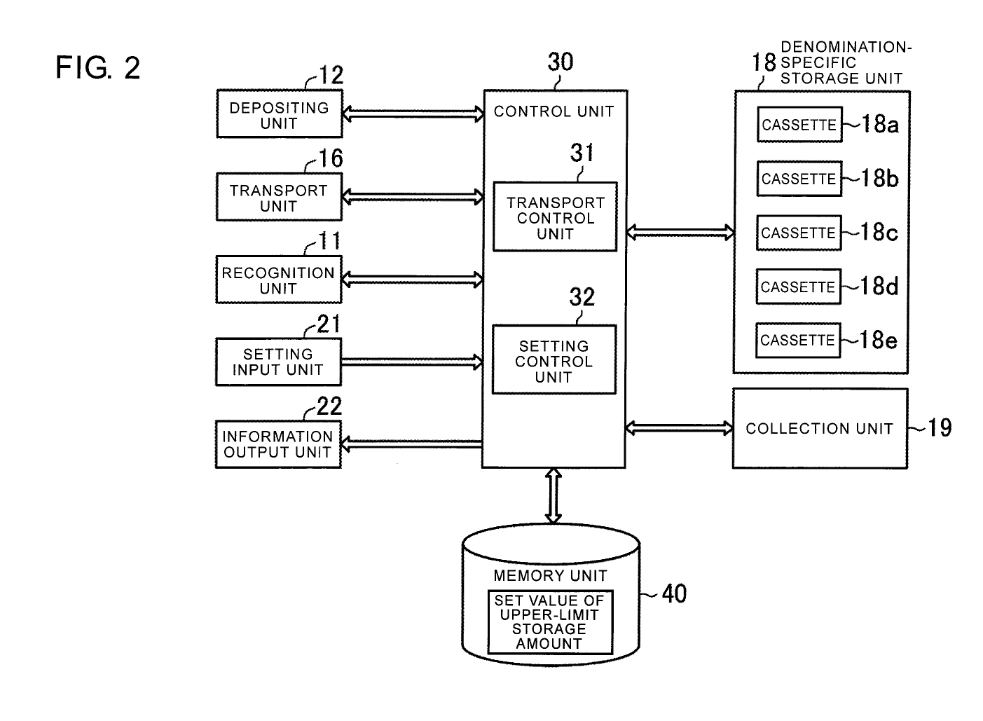

FIG. 2 is a block diagram showing a functional structure of the banknote handling apparatus 1. In FIG. 2, only the components that are necessary for explaining the features of the present embodiment are shown, and other general components are omitted.

A control unit 30 includes a transport control unit 31 and a setting control unit 32. The transport control unit 31 controls a destination of banknotes transported by the transport unit 16 on the basis of a result of recognition by the recognition unit 11. For example, when a banknote inserted into the depositing unit 12 is a 10-dollar fit note, the transport control unit 31 controls the transport unit 16 so that this banknote is stored in the cassette 18c. When a banknote inserted into the depositing unit 12 is an unfit note or a banknote of a denomination that is not assigned to the denomination-specific storage unit 18, the transport control unit 31 controls the transport unit 16 so that this banknote is stored in the collection unit 19. Further, the transport control unit 31 manages the amount of banknotes of each denomination stored in the collection unit 19. A memory unit 40 stores therein an upper-limit storage amount of banknotes in the collection unit 19. In this embodiment, the memory unit 40 stores, as a set value of the upper-limit storage amount, the limited number of banknotes.

A setting input unit 21, which is not shown in FIG. 1, is implemented by, for example, a combination of a liquid crystal panel and an input switch or by a liquid crystal touch panel. The setting control unit 32 can set or change the upper-limit storage amount in the collection unit 19, which is stored in the memory unit 40, in accordance with an input of setting through the setting input unit 21. A user is allowed to set the limited number of banknotes in the collection unit 19 through the setting input unit 21.

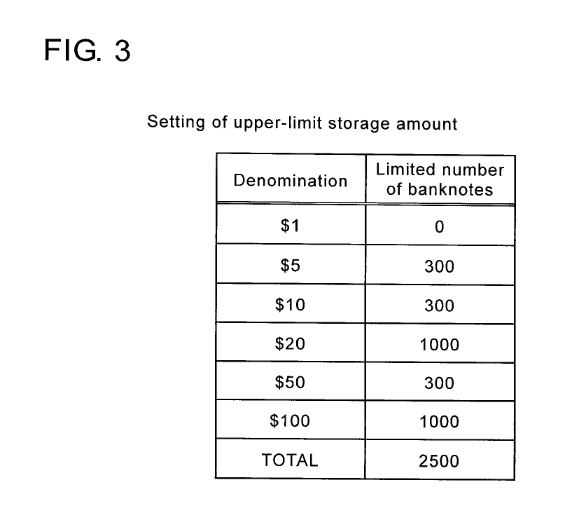

FIG. 3 shows an example of set values of the limited numbers of banknotes. In the example shown in FIG. 3, for example, the limited number of banknotes is set for each denomination, such as “300” for 5-dollar notes, “300” for 10-dollar notes, and so on. As for 1-dollar notes, “0” is set as the limited number of banknotes, which means that substantially no limit is placed on the number of 1-dollar notes. The total limited number of banknotes in the collection unit 19 is set to “2500”.

The transport control unit 31, with reference to the memory unit 40, controls a destination of banknotes transported by the transport unit 16 so that the number of banknotes for each denomination stored in the collection unit 19 does not exceed the limited number of banknotes that is stored in the memory unit 40.

Further, the control unit 30 can output, for example, a message to the user from an information output unit 22 such as a display or an audio output device provided in the banknote handling apparatus 1.

A part or entirety of the function of the control unit 30 is implemented by hardware or software. For example, the control unit 30 can be implemented by a circuit configured on a control substrate provided in the banknote handling apparatus 1, a microcomputer that executes a stored program, or the like. The control unit 30 may be configured separately from or integrally with other control units provided in the banknote handling apparatus 1.

(Example of Operation)

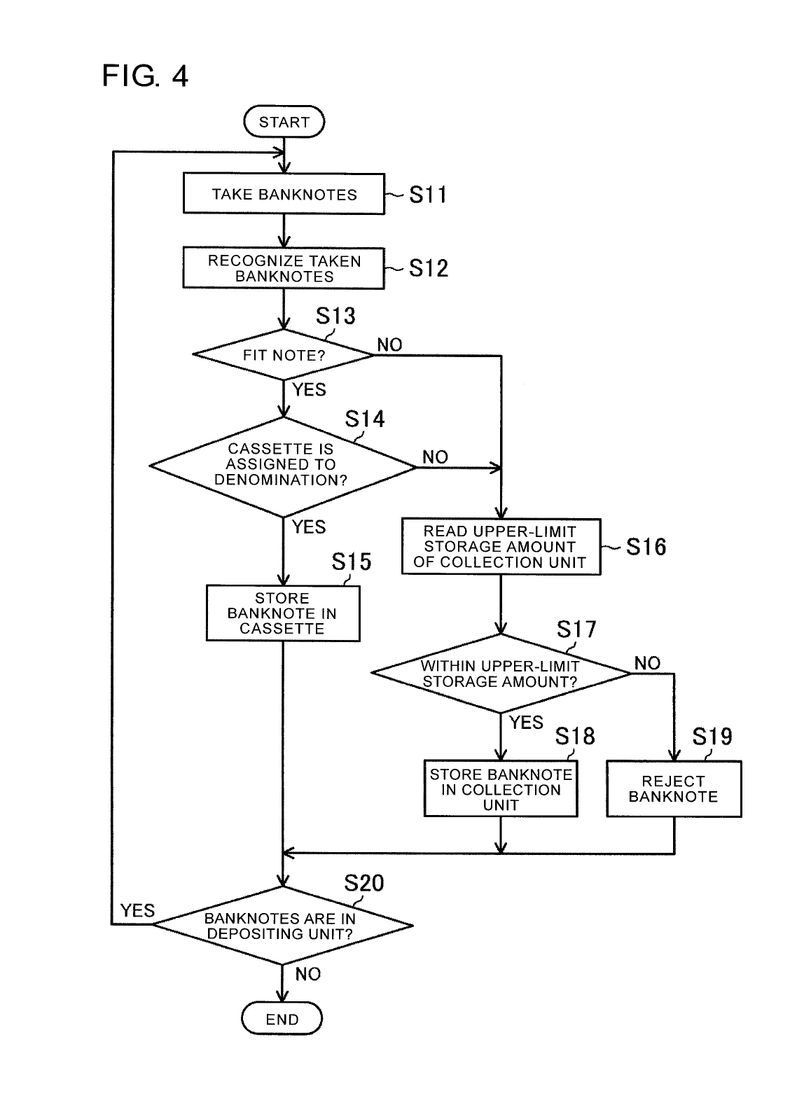

FIG. 4 is a flowchart showing an example of operation in depositing. With reference to FIG. 4, when a user inserts banknotes in the depositing unit 12, the depositing unit 12 takes the banknotes one by one (S11). The taken banknotes are transported by the transport unit 16, and the denomination, fitness, and the like of each banknote are recognized by the recognition unit 11 (S12).

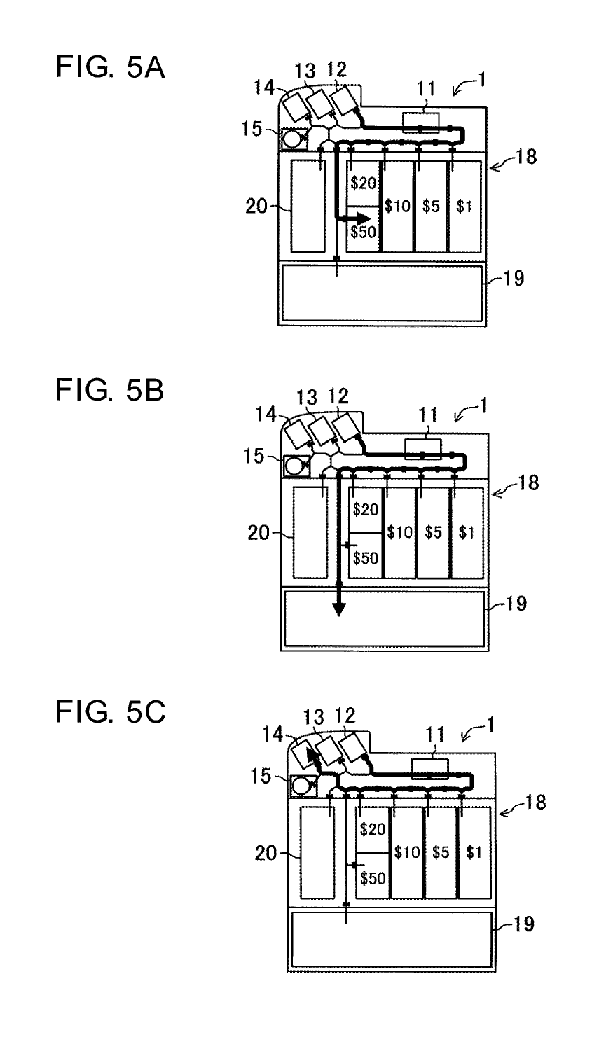

When a banknote is a fit note (Yes in S13) and any one of the cassettes 18a to 18e of the denomination-specific storage unit 18 is assigned to the denomination of this banknote (Yes in S14), the transport control unit 31 controls the transport unit 16 so that this banknote is stored in the assigned cassette among the cassettes 18a to 18e as shown in FIG. 5A (S15). For example, when the banknote is a 50-dollar fit note, this banknote is stored in the cassette 18e. On the other hand, when a banknote is an unfit note (No in S13) or when none of the cassettes 18a to 18e of the denomination-specific storage unit 18 is assigned to the denomination of the banknote (No in S14), the handling process proceeds to step S16.

In step S16, the transport control unit 31 reads the upper-limit storage amount of the collection unit 19 from the memory unit 40. In this embodiment, the limited number of banknotes for each denomination as shown in FIG. 3 is read as the set value of the upper-limit storage amount. Then, the transport control unit 31 compares the amount of banknotes stored in the collection unit 19 with the upper-limit storage amount read from the memory unit 40, and determines whether or not the amount of banknotes stored in the collection unit 19 is within the upper-limit storage amount (S17). At this time, the total amount of banknotes stored in the collection unit 19 is compared with the upper-limit storage amount, and the amount of stored banknotes corresponding to the denomination of the transported banknote is also compared with the upper-limit storage amount for the denomination. Then, when the amount of banknotes stored in the collection unit 19 is, as a whole and with respect to the denomination of the transported banknote, within the upper-limit storage amount (Yes in S17), the transport control unit 31 controls the transport unit 16 so that the banknote is stored in the collection unit 19 as shown in FIG. 5B (S18). On the other hand, when the amount of banknotes stored in the collection unit 19 is not within the upper-limit storage amount (No in S17), the transport control unit 31 controls the transport unit 16 so that the banknote is transported to the depositing reject unit 14 as shown in FIG. 5C (S19). The above-mentioned control avoids the situation that, in depositing, banknotes of each denomination are stored in the collection unit 19, exceeding the upper-limit storage amount set in the memory unit 40.

For example, when a taken banknote is a 100-dollar note, since none of the cassettes 18a to 18e of the denomination-specific storage unit 18 is assigned to this denomination, the handling process proceeds to S16. Then, when the total number of banknotes in the collection unit 19 is less than or equal to 2,500 and the number of 100-dollar notes is less than or equal to 1,000, the 100-dollar note is stored in the collection unit 19 (S18). On the other hand, when the total number of banknotes in the collection unit 19 exceeds 2,500 or when the number of 100-dollar notes in the collection unit 19 exceeds 1,000, the 100-dollar note is rejected (S19).

The above-mentioned handling is repeatedly executed until the banknotes inserted into the depositing unit 12 are gone (S20).

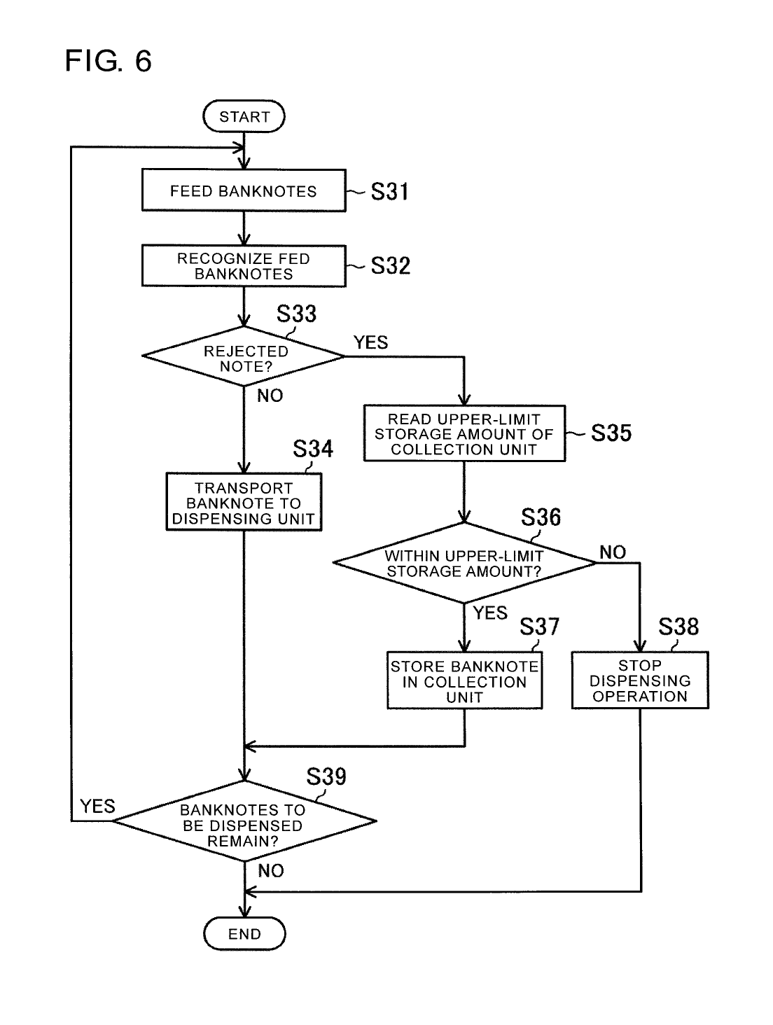

FIG. 6 is a flowchart showing an example of operation in dispensing. In FIG. 6, when a user performs an operation for dispensing, the denomination-specific storage unit 18 feeds a banknote of a specified denomination (S31). The fed banknote is transported by the transport unit 16, and recognized by the recognition unit 11 (S32).

When the banknote is recognized to be appropriate for dispensing by the recognition unit 11 (No in S33), the transport control unit 31 controls the transport unit 16 so that the banknote is transported to the dispensing unit 13 (S34). On the other hand, when the banknote is recognized to be inappropriate for dispensing by the recognition unit 11, that is, when the banknote is a dispense-rejected banknote (rejected note) (Yes in S33), the handling process proceeds to step S35.

In step S35, the transport control unit 31 reads the upper-limit storage amount of the collection unit 19 from the memory unit 40. In this embodiment, the limited number of banknotes for each denomination as shown in FIG. 3 is read as the set value of the upper-limit storage amount. Then, the transport control unit 31 compares the amount of banknotes stored in the collection unit 19 with the upper-limit storage amount read from the memory unit 40, and determines whether or not the amount of banknotes stored in the collection unit 19 is within the upper-limit storage amount (S36). At this time, the total amount of banknotes stored in the collection unit 19 is compared with the upper-limit storage amount, and the amount of stored banknotes corresponding to the denomination of the dispense-rejected banknote is also compared with the upper-limit storage amount for the denomination. Then, when the amount of banknotes stored in the collection unit 19 is, as a whole and with respect to the denomination of the dispense-rejected banknote, within the upper-limit storage amount (Yes in S36), the transport control unit 31 controls the transport unit 16 so that the dispense-rejected banknote is stored in the collection unit 19 (S37). On the other hand, when the amount of banknotes stored in the collection unit 19 is not within the upper-limit storage amount (No in S36), the transport control unit 31 stops the dispensing operation (S38). The reason why the dispensing operation is stopped is that it is difficult to continue the dispensing operation unless a destination of the dispense-rejected banknote is determined. The above-mentioned control avoids the situation that banknotes of each denomination are stored in the collection unit 19, exceeding the upper-limit storage amount set in the memory unit 40.

For example, when a 10-dollar note is dispensed from the cassette 18c, if this banknote is a dispense-rejected banknote, the handling process proceeds to step S35. When, in the collection unit 19, the total number of banknotes is less than or equal to 2,500 and the number of 10-dollar notes is less than or equal to 300, the 10-dollar note as the dispense-rejected banknote is stored in the collection unit 19 (S37). On the other hand, when, in the collection unit 19, the total number of banknotes exceeds 2,500 or the number of 10-dollar notes exceeds 300, the dispensing operation is stopped.

The above-mentioned handling is repeatedly executed until banknotes to be dispensed are gone (S39).

According to the above-mentioned structure and operation, banknotes of each denomination are prevented from being stored in the collection unit 19, exceeding the upper-limit storage amount set in the memory unit 40. That is, in the collection unit 19, it is possible to limit the amount of stored banknotes of a denomination for which an upper-limit storage amount is stored in the memory unit 40. Thus, a storage amount of banknotes for other denominations can be secured in the collection unit 19. Accordingly, it is possible to avoid the situation that banknotes of a specific denomination occupy the collection unit 19, and banknotes of other denominations cannot be stored in the collection unit 19.

(Examples of Other Handling Methods)

In the example shown in FIG. 3, the upper-limit storage amount in the collection unit 19 is set by using the number of banknotes. However, the form of data that is set as an upper-limit storage amount is not limited thereto. For example, an upper-limit storage amount may be set by using the monetary amount of banknotes. For example, an upper limit of 3,000 dollars may be set for 10-dollar notes, and an upper limit of 15,000 dollars may be set for 50-dollar notes. Alternatively, an upper-limit storage amount may be set by using the ratio of the amount of banknotes stored in the collection unit 19, to the maximum storage capacity of the collection unit 19. For example, an upper limit of 12% may be set for 5-dollar notes, and an upper limit of 20% may be set for 20-dollar notes.

In the example shown in FIG. 3, the sum of the limited numbers of banknotes for the respective denominations is not equal to the total limited number of banknotes. That is, in this example, the setting control unit 32 is configured to allow the situation that the sum of the limited numbers of banknotes for the respective denominations are not equal to the total limited number of banknotes. In contrast to this, the setting control unit 32 may be configured to perform control such that setting of an upper-limit storage amount cannot be completed unless the sum of the limited numbers of banknotes for the respective denominations is equal to the total limited number of banknotes.

In the example shown in FIG. 3, the limited number of banknotes is set for 100-dollar notes, in addition to the respective denominations assigned to the denomination-specific storage unit 18, that is, 1-dollar notes, 5-dollar notes, 10-dollar notes, 20-dollar notes, and 50-dollar notes. However, the pattern of selecting denominations for which upper-limit storage amounts are set is not limited thereto. For example, upper-limit storage amounts may be set for some of the denominations assigned to the denomination-specific storage unit 18. If the limited number of banknotes is set for at least one of the denominations of banknotes to be stored in the collection unit 19, it is possible to secure a storage amount for the other denominations in the collection unit 19.

In the above-mentioned operation, the condition for storing a banknote in the collection unit 19 is, in depositing, that the banknote is an unfit note or that the denomination of a banknote is not assigned to the denomination-specific storage unit 18, while the condition is, in dispensing, that the banknote is a rejected banknote. However, the condition for storing a banknote in the collection unit 19 is not limited to that mentioned above, and the above-mentioned condition is not essential. For example, in depositing, when a cassette to which the denomination of a banknote is assigned is full and cannot store the banknote any more, that is, when the banknote is a deposit-overflow banknote, the banknote may be stored in the collection unit 19.

As an alternative handling method, in order to collect banknotes from the denomination-specific storage unit 18, the banknotes may be stored in the collection unit 19. In this case, the transport control unit 31 may temporarily cancel the limitation based on the upper-limit storage amount to store the banknotes in the collection unit 19.

When the amount of banknotes stored in the collection unit 19 approaches the upper-limit storage amount, for example, when the number of banknotes of a certain denomination approaches the limited number, the control unit 30 may notify the user of this situation through the information output unit 22. At this time, a notification that prompts the user to temporarily change the upper-limit storage amount may be made. When the upper-limit storage amount has been temporarily changed, this change may be canceled at a predetermined time. For example, if the user temporarily changes the upper-limit storage amount while storage of banknotes from the denomination-specific storage unit 18 to the collection unit 19 is being executed, the temporary change of the upper-limit storage amount may be canceled at the time when the banknotes have been collected from the collection unit 19.

(Example of Setting Upper-Limit Storage Amount for Each Handling Type)

In the above-mentioned example, the upper-limit storage amount in the collection unit 19 is set for each denomination. However, in the present disclosure, “denomination” is an example of a kind for which an upper-limit storage amount is individually set, and an upper-limit storage amount may be set for each of kinds other than “denomination”. In the present embodiment, “kind” is based on at least one of a result of recognition by the recognition unit 11 and a result of handling by the apparatus.

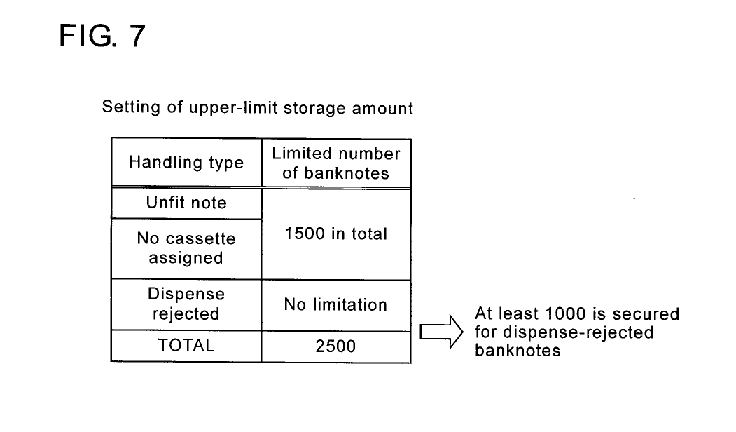

For example, an upper-limit storage amount may be set for each handling type, that is, for each handling mode of the banknote handling apparatus 1. FIG. 7 shows an example of an upper-limit storage amount set for each handling type. In the example shown in FIG. 7, in a case where, in depositing, a banknote is an unfit note or the denomination of a banknote is not assigned to the denomination-specific storage unit 18, “1,500 in total” is set as the limited number of banknotes. On the other hand, in a case where, in dispensing, a banknote is a rejected note, no limit number is set. Further, “2,500” is set as the total limited number of banknotes in the collection unit 19. According to the above-mentioned setting, as the number of banknotes stored in the collection unit 19, at least “1,000” is secured for dispense-rejected banknotes. Other examples of the handling type for which an upper-limit storage amount is set may include: deposit-overflow banknotes, collection of banknotes from the denomination-specific storage unit 18, and the like. The transport control unit 31 manages the amount of banknotes, stored in the collection unit 19, for each of the handling types. Dispense-rejected banknotes may be stored in only the collection unit 19 in the banknote handling apparatus 1.

In this case, for example, the banknote handling apparatus 1 operates as follows. It is assumed that, in depositing, the banknote handling apparatus 1 operates according to the flowchart shown in FIG. 4. When a banknote is an unfit note (No in S13) or when none of the cassettes 18a to 18e of the denomination-specific storage unit 18 is assigned to the denomination of a banknote (No in S14), the handling process proceeds to step S16. The transport control unit 31 reads, from the memory unit 40, the upper-limit storage amount in the collection unit 19. In this example, the limited number of banknotes for each handing type as shown in FIG. 7 is read as the set value of the upper-limit storage amount. Then, the transport control unit 31 compares the amount of banknotes stored in the collection unit 19 with the upper-limit storage amount read from the memory unit 40, and determines whether or not the amount of banknotes stored in the collection unit 19 is within the upper-limit storage amount (S17). At this time, the total amount of banknotes stored in the collection unit 19 is compared with the upper-limit storage amount, and the amount of stored banknotes corresponding to the handling type of the transported banknote is also compared with the upper-limit storage amount. Then, when the amount of banknotes stored in the collection unit 19 is, as a whole and with respect to the handling type of the transported banknote, within the upper-limit storage amount (Yes in S17), the transport control unit 31 controls the transport unit 16 so that the banknote is stored in the collection unit 19 (S18). On the other hand, when the amount of banknotes stored in the collection unit 19 is not within the upper-limit storage amount (No in S17), the transport control unit 31 controls the transport unit 16 so that the banknote is transported to the depositing reject unit 14 (S19).

In dispensing, the banknote handling apparatus 1 operates according to the flowchart shown in FIG. 6. When a banknote is a dispense-rejected banknote (rejected note) (Yes in S33), the handling process proceeds to step S35. In step S35, the transport control unit 31 reads, from the memory unit 40, the upper-limit storage amount in the collection unit 19. In this example, the limited number of banknotes for each handing type as shown in FIG. 7 is read as the set value of the upper-limit storage amount. Then, the transport control unit 31 compares the amount of banknotes stored in the collection unit 19 with the upper-limit storage amount read from the memory unit 40, and determines whether or not the amount of banknotes stored in the collection unit 19 is within the upper-limit storage amount (S36). At this time, the total amount of banknotes stored in the collection unit 19 is compared with the upper-limit storage amount, and the amount of stored dispense-rejected banknotes is also compared with the upper-limit storage amount (no limitation is set in the example shown in FIG. 7). When the amount of banknotes stored in the collection unit 19 is, as a whole and with respect to the dispense-rejected banknotes, within the upper-limit storage amount (Yes in S36), the transport control unit 31 controls the transport unit 16 so that the dispense-rejected banknote is stored in the collection unit 19 (S37). On the other hand, when the amount of banknotes stored in the collection unit 19 is not within the upper-limit storage amount (No in S36), the transport control unit 31 stops the dispensing operation (S38).

The above-mentioned structure and operation avoid the situation that banknotes of each handling type are stored in the collection unit 19, exceeding the upper-limit storage amount set in the memory unit 40. That is, in the collection unit 19, the amount of stored banknotes of a handling type for which the upper-limit storage amount is stored in the memory unit 40 can be limited. Thus, a storage amount of banknotes for other handling types can be secured in the collection unit 19. Thus, a storage amount of banknotes for other handling types can be secured in the collection unit 19. Accordingly, it is possible to avoid the situation that banknotes of a specific handling type occupy the collection unit 19 and banknotes of other handing types cannot be stored in the collection unit 19.

In the above structure, the collection unit 19 is provided separately from the denomination-specific storage unit 18. The collection unit 19 is an example of a second storage unit which stores at least dispense-rejected money that has been recognized as being inappropriate for dispensing by the recognition unit 11 during dispensing. When, in depositing, an inserted banknote satisfies a predetermined condition, the transport control unit 31 controls the transport unit 16 so that this banknote is transported to the collection unit 19. In this case, however, if the amount of banknotes stored in the collection unit 19 has reached the set upper-limit storage amount (1500 notes in FIG. 7) in depositing, the transport control unit 31 restricts transport of this banknote to the collection unit 19. Thus, the amount of banknotes stored in the collection unit 19 in depositing can be limited, whereby a storage amount of dispense-rejected banknotes can be secured.

Further, in the above-mentioned structure, the predetermined condition for storing an inserted banknote in the collection unit 19 in depositing is that the banknote is an unfit note or that the denomination of the banknote is not assigned to the denomination-specific storage unit 18. However, the condition for storing a banknote in the collection unit 19 is not limited to the above-mentioned condition, and the above-mentioned condition is not essential. For example, a deposit-overflow banknote may be stored in the collection unit 19. That is, the predetermined condition may include at least one of: a condition that the amount of banknotes, for the denomination of the inserted banknote, stored in the denomination-specific storage unit 18 has reached the upper-limit amount; a condition that the denomination of the banknote is assigned to none of the denomination-specific storage units 18; and a condition that the banknote is recognized as an unfit note by the recognition unit 11.

The predetermined condition for storing an inserted banknote in the collection unit 19 may include a plurality of conditions having different upper-limit storage amounts. For example, the predetermined condition may include a condition that a banknote is an unfit note and a condition that the denomination of the banknote is not assigned to the denomination-specific storage unit 18, and the upper-limit storage amount in the case where the banknote is an unfit note may be set to 500 notes while the upper-limit storage amount in the case where the denomination of the banknote is not assigned to the denomination-specific storage unit 18 may be set to 1,000 notes.

The transport control unit 31 may be configured to be able to cancel restriction on transport of a banknote to the collection unit 19 on the basis of the set upper-limit storage amount in depositing. Thus, restriction on transport of a banknote to the collection unit 19 on the basis of the set upper-limit storage amount in depositing can be canceled according to need.

(Other Examples of Setting Upper-Limit Storage Amounts)

An upper-limit storage amount may be set for each of banknote types (e.g., fit note/unfit note, new-version note/old-version note, and the like) other than denominations. In this case, an upper-limit storage amount may be set for each type among all banknotes, or an upper-limit storage amount may be set for each type among banknotes of the same denomination.

An upper-limit storage amount may be set not for each denomination but for each of categories into which banknotes are sorted on the basis of denominations. For example, banknotes may be sorted into large denomination notes and small denomination notes according to denominations, and an upper-limit storage amount may be set for each of the categories. Alternatively, banknotes may be sorted into banknotes of abundantly circulated denominations and banknotes of less circulated denominations, and an upper-limit storage amount may be set for each of the categories. Still alternatively, an upper-limit storage amount may be set for a combination of a plurality of denominations.

Yet alternatively, an upper-limit storage amount may be set for a combination of some of the above-mentioned kinds. For example, regarding banknotes of a certain denomination, an upper-limit storage amount thereof may be changed for each handling type. For example, regarding 20-dollar notes, different upper-limit storage amounts may be set such that “500” is set for deposit-overflow banknotes, “500” is set for unfit notes, and “1,000” is set in total.

(Alternative Structures of Storage Unit in Present Disclosure)

In the above embodiment, the collection unit 19 as an example of a storage unit has a cassette type structure. However, the present disclosure is not limited thereto. For example, a pouch (bag) type collection unit and a tape (drum) type collection unit may be adopted. Further, although the collection unit 19 is only for storing banknotes therein and does not include a feeding mechanism in the above embodiment, the collection unit 19 may be configured to be able to feed banknotes.

The collection unit 19 is provided separately from the denomination-specific storage unit 18. However, setting of an upper-limit storage amount as described above may be performed on a storage unit configured such that other storage units are not provided in the apparatus. Also in this case, in the storage unit, the amount of stored banknotes of a predetermined kind for which an upper-limit storage amount is stored in a memory can be limited, whereby a storage amount of banknotes in the storage unit can be secured for the kinds other than the predetermined kind among the plurality of kinds.

Although the banknote handling apparatus has been described above, the above-described structure and operation may be applied to a coin handling apparatus. Also in this case, the same function and effect as described above can be achieved.

What is claimed is:

1. A money handling apparatus configured to handle money, comprising:
a recognition unit configured to recognize money to be handled;
a storage unit configured to store money of a plurality of kinds, on the basis of at least one of a result of recognition by the recognition unit and a result of handling by the money handling apparatus; and
a memory unit configured to store, for at least one kind among the plurality of kinds, an upper-limit storage amount of money in the storage unit.

2. The money handling apparatus according to claim 1, comprising:
a transport unit configured to transport the money being handled; and
a transport control unit configured to control, with reference to the memory unit, a destination of the money transported by the transport unit, so that an amount of the money of the at least one kind stored in the storage unit does not exceed the upper-limit storage amount stored in the memory unit.

3. The money handling apparatus according to claim 1, wherein
the memory unit stores, as the upper-limit storage amount, a number of pieces of the money of the kind, a monetary amount of the money of the kind, or a ratio of an amount of the money of the kind stored in the storage unit to a maximum storage capacity of the storage unit.

4. The money handling apparatus according to claim 1, comprising a setting control unit capable of changing the upper-limit storage amount that is stored in the memory unit.

5. The money handling apparatus according to claim 1, comprising a denomination-specific storage unit configured to store money by denominations, wherein
the storage unit and the denomination-specific storage unit are managed under different authorities.

6. The money handling apparatus according to claim 1, wherein the storage unit is a storage-only unit that performs only storage of money.

7. The money handling apparatus according to claim 1, wherein
in a depositing process of depositing money into the apparatus, in a case where inserted money is determined to be stored in the storage unit, when the money belongs to any of the at least one kind and an amount of the money of the kind stored in the storage unit has reached the upper-limit storage amount, the money is rejected, and the depositing process is continued.

8. The money handling apparatus according to claim 1, wherein
in a dispensing process of dispensing money to the outside of the apparatus, in a case where money to be dispensed is determined to be stored in the storage unit, when the money belongs to any of the at least one kind and an amount of the money of the kind stored in the storage unit has reached the upper-limit storage amount, the dispensing process is stopped.

9. A money handling apparatus configured to handle money, comprising:
an insertion unit into which money is inserted;
a dispensing unit from which money is dispensed;
a denomination-specific storage unit configured to store money by denominations;
a transport unit configured to transport money inserted into the insertion unit in a depositing process, and transport money fed from the denomination-specific storage unit in a dispensing process;
a recognition unit configured to recognize the money transported by the transport unit;
a second storage unit provided separately from the denomination-specific storage unit, and configured to store at least dispense-rejected money that is recognized by the recognition unit as being inappropriate for dispensing in the dispensing process; and
a transport control unit configured to control a destination of the money transported by the transport unit, on the basis of at least a result of recognition by the recognition unit, wherein
in the depositing process, the transport control unit controls the transport unit to transport the money to the second storage unit when the inserted money satisfies a predetermined condition, and restricts transport of the money to the second storage unit when an amount of money stored in the second storage unit has reached a set upper-limit storage amount in the depositing process.

10. The money handling apparatus according to claim 9, wherein
the predetermined condition includes at least one of: a condition that an amount of money, corresponding to the denomination of the inserted money, stored in the denomination-specific storage unit has reached an upper-limit storage amount; a condition that the denomination of the money is assigned to none of the denomination-specific storage unit; and a condition that the money is recognized as an unfit note by the recognition unit.

11. The money handling apparatus according to claim 9, wherein
the dispense-rejected money is stored only in the second storage unit in the money handling apparatus.

12. The money handling apparatus according to claim 9, wherein
the transport control unit is configured to be able to cancel restriction on transport of money to the second storage unit on the basis of the set upper-limit storage amount in the depositing process.

13. A method of handling money in a money handling apparatus, comprising:
transporting, by a transport unit, money being handled;
recognizing, by a recognition unit, the money being transported by the transport unit;
controlling, by a transport control unit, the transport unit so that, among the money transported by the transport unit, money of a plurality of kinds are stored in a storage unit, on the basis of at least one of a result of recognition by the recognition unit and a result of handling by the money handling apparatus; and
controlling, by the transport control unit, with reference to a memory unit that stores an upper-limit storage amount of money in the storage unit, a destination of the money transported by the transport unit so that, regarding at least one kind among the plurality of kinds, an amount of money of the at least one kind stored in the storage unit does not exceed the upper-limit storage amount stored in the memory unit.

14. A method of handling money in a money handling apparatus, comprising:
transporting, by a transport unit, money in a depositing process, and transporting, by the transport unit, money fed from a denomination-specific storage unit in a dispensing process;
recognizing, by a recognition unit, the money being transported by the transport unit;
controlling, by a transport control unit, the transport unit so that dispense-rejected money that is recognized to be inappropriate for dispensing by the recognition unit in the dispensing process is stored in a second storage unit provided separately from the denomination-specific storage unit; and
controlling, by the transport control unit, the transport unit so that, when inserted money satisfies a predetermined condition in the depositing process, the money is transported to the second storage unit, and restricting, by the transport control unit, transport of the money to the second storage unit when an amount of money stored in the second storage unit has reached a set upper-limit storage amount in the depositing process.
